(19) United States
(12) Patent Application Publication
(10) Pub. No.: US 2016/0061347 A1
(43) Pub. Date: Mar. 3, 2016

(54) VALVE CONTROL APPARATUS

(71) Applicant: DENSO CORPORATION, Kariya-city (JP)

(72) Inventor: Fuminori SUZUKI, Okazaki-city (JP)

(21) Appl. No.: 14/818,533

(22) Filed: Aug. 5, 2015

(30) Foreign Application Priority Data
Aug. 28, 2014 (JP) 2014-174134

(51) Int. Cl. F16K 37/00; G05D 7/06; F16K 31/06

(52) U.S. Cl. CPC F16K 37/0041; F16K 31/0603; G05D 7/0635

(57) ABSTRACT

A TCU controlling a linear solenoid valve includes an inspecting portion which supplies an inspecting electricity to the solenoid; an initial-response time computing portion which computes an initial response time that has elapsed from the inspecting portion commands to generate the inspecting electricity until the spool valve starts moving; a slowdown-determining portion which determines that a motion of the spool valve has become slow when the initial response time is longer than or equal to a determination time; and a PM-removing portion performs a PM-removing operation for removing foreign matters between the valve body and the spool valve only when it is determined that the movement of the spool valve has become slow. By determining whether the movement of the spool valve has become slow based on the initial response time, it can be estimated whether foreign matters exist. When it is estimated that foreign matters exist, the PM-removing operation is performed.

### CROSS-REFERENCE TO RELATED APPLICATION

This application is based on Japanese Patent Application No. 2014-174134 filed on Aug. 28, 2014, the disclosure of which is incorporated herein by reference.

### TECHNICAL FIELD

The present disclosure relates to a valve control apparatus which controls a linear solenoid valve.

### BACKGROUND

It is known that a linear solenoid valve controls hydraulic pressure or flow rate continuously. For example, the linear solenoid valve is provided to a hydraulic circuit of a transmission for a vehicle, and the linear solenoid valve adjusts the hydraulic fluid supplied to friction engagement elements such as a clutch and other valves.

It is likely that the hydraulic fluid passing through a linear solenoid valve may include foreign matters. When the foreign matters are accumulated in a valve body, it is likely that a movement of the valve body becomes slow or the valve body may be adhered. JP-4-119254A shows a hydraulic control system in which the valve body is vibrated at a specified time period in order to remove foreign matters.

However, in the hydraulic control system shown in JP-4-119254A, the valve body is vibrated periodically without respect to the existence of foreign matters, which causes useless power consumption.

### SUMMARY

It is an object of the present disclosure to provide a valve control apparatus which is able to reduce power consumption.

According to an aspect of the present disclosure, a valve control apparatus controls a linear solenoid valve. The valve control apparatus has an inspecting portion, an initial-response time computing portion, a slowdown-determining portion, and the PM-removing portion. The inspecting portion supplies inspecting electricity toward the solenoid for a predetermined period. The initial-response time computing portion computes an initial response time which is a time period that has elapsed from the inspecting portion commands to generate the inspecting electricity until the spool starts moving. When the initial response time is not less than the specified determination time, the slowdown-determining portion determines that the movement of the spool has become slow. Only when it is determined that the movement of the spool has become slow, the PM-removing portion performs a PM-removing operation for removing foreign matters between the valve body and the spool.

By determining whether the movement of the spool has become slow based on the initial response time, it can be estimated whether foreign matters exist. When it is estimated that foreign matters exist, the PM-removing operation is performed.

Therefore, when there is no foreign matter, it can avoid to perform the PM-removing operation and to consume useless electric power. Thus, according to the present disclosure, electric power consumption can be reduced.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a chart showing a schematic structure of an automatic transmission in which a transmission control unit is applied;

FIG. 2 is a chart showing the transmission control unit, a linear solenoid valve, and a clutch;

FIG. 3 is a block diagram showing a function of the transmission control unit;

FIG. 4 is a first flowchart for explaining an operation of the transmission control unit;

FIG. 5 is a second flowchart for explaining an operation of the transmission control unit;

FIG. 6 is a first time chart showing a relationship between a current command value of solenoid, an actual electricity flowing through the solenoid, a stroke of a spool, and an output oil pressure of the linear solenoid valve;

FIG. 7 is a second time chart showing a relationship between a current command value of solenoid, an actual electricity flowing through the solenoid, a stroke of a spool, and an output oil pressure of the linear solenoid valve; and

FIG. 8 is a third time chart showing a relationship between a current command value of solenoid, an actual electricity flowing through the solenoid, a stroke of a spool, and an output oil pressure of the linear solenoid valve.

### DETAILED DESCRIPTION

Multiple embodiments of the present invention will be described with reference to accompanying drawings.

### First Embodiment

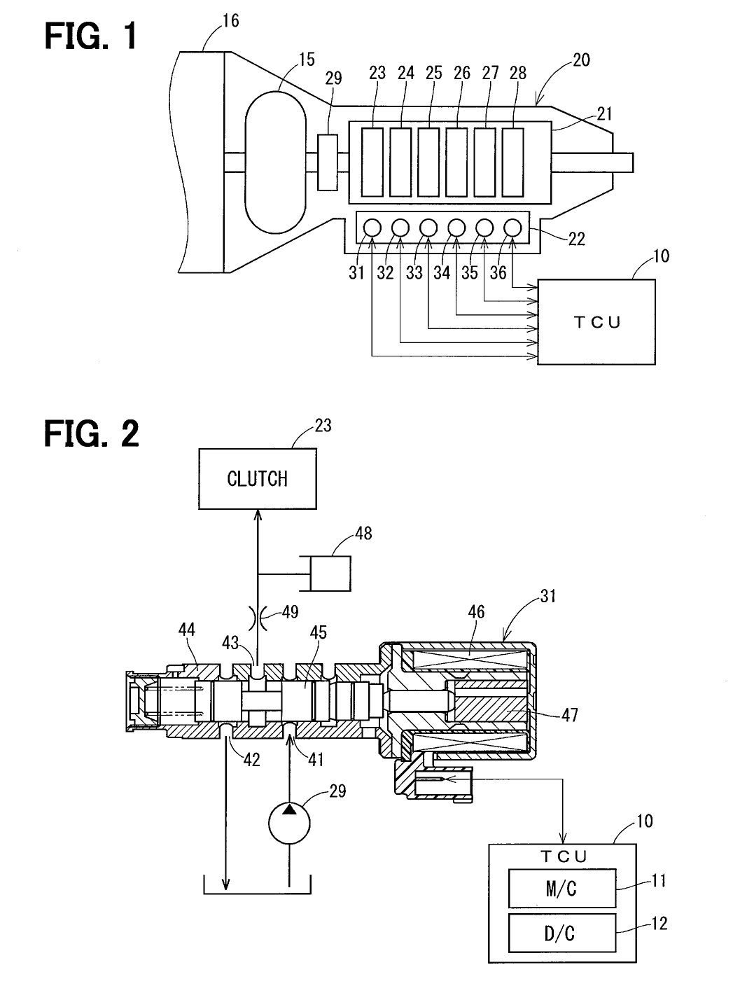

FIG. 1 shows a transmission control unit as a valve control apparatus. The transmission control unit 10 is provided to an automatic transmission 20 for a vehicle. Hereinafter, the transmission control unit is referred to as “TCU.”

### Configuration of Automatic Transmission 20

With reference to FIGS. 1 and 2, a configuration of the automatic transmission 20 will be explained. The automatic transmission 20 is provided with a shifting system 21 connected to an engine 16 through a torque converter 15, an oil-pressure-control portion 22, and the TCU 10.

The shifting system 21 has multiple friction engagement elements including clutches 23-25 and brakes 26-28. A transmission gear ratio is changed by engaging each friction engagement element selectively. FIG. 2 shows only one clutch 23 for convenience.

The oil-pressure-control portion 22 has multiple linear solenoid valves 31-36 which adjust the hydraulic pressure of transmission oil supplied from an oil pump 29. FIG. 2 shows only one linear solenoid valve 31 for convenience.

As shown in FIG. 2, the linear solenoid valve 31 has a valve body 44 which includes a supply port 41, a drain port 42 and a discharge port 43, a spool valve 45, and a solenoid 46 which drives the spool valve 45. A moving core 47 of the solenoid 46 moves in an axial direction according to magnetizing current of the solenoid 46. The spool valve 45 moves in the axial direction with the moving core 47, and changes output oil pressure according to its axial position. A damper 48 and a throttle valve 49 are for reducing pulsation of operating oil pressure.

The TCU 10 is comprised of a microcomputer 11, a drive circuit 12 and the like. The microcomputer 11 is electrically connected to various sensors and the solenoid 46. Based on the detected value of the sensors, the microcomputer 11 computes a target value of the output oil pressure of the linear solenoid valves 31-36 and a current command value of the solenoid 46. The drive circuit 12 energizes the solenoid 46 based on the computed current command value. The TCU 10 varies the axial position of the spool valve 45 by controlling the energization of the solenoid 46 so as to control the oil pressure supplied to each friction engagement element.

### Configuration of TCU 10

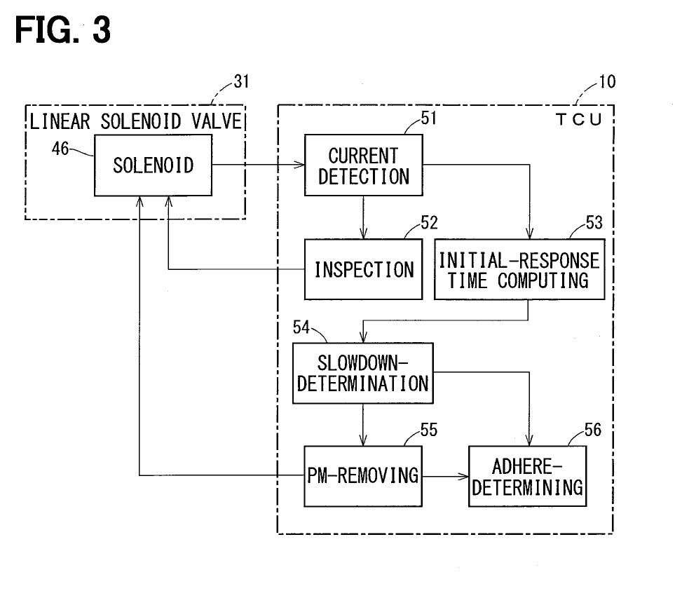

Referring to FIG. 3, the configuration of the TCU 10 will be explained.

The TCU 10 has a function for removing foreign matters between the valve body 44 of the linear solenoid valves 31-36 and the spool valve 45. As shown in FIG. 3, specifically, the TCU 10 is provided with a current detecting portion 51, an inspecting portion 52, an initial-response time computing portion 53, a slowdown-determining portion 54, a PM-removing portion 55, and an adhere-determining portion 56.

The current detecting portion 51 detects actual electricity which flows through the solenoid 46.

The inspecting portion 52 supplies inspecting electricity toward the solenoid 46 for a predetermined period. In the present embodiment, the inspecting portion 52 supplies the inspecting electricity when the linear solenoid valve 31 is not operated. Based on the detected value of the current detecting portion 51, it is determined whether the linear solenoid valve 31 is operated. The inspecting electricity is small electricity which varies the output oil pressure of the linear solenoid valve 31 without engaging of clutch 23.

The initial-response time computing portion 53 computes an initial response time Ts which is a time period that has elapsed from the inspecting portion 52 commands to generate the inspecting electricity until the spool valve 45 starts moving. In the present embodiment, the initial response time Ts is defined as a time period that has elapsed from the inspecting portion 52 commands to generate the inspecting electricity until the detected value of the current detecting portion 51 starts descending after rising.

When the initial response time Ts is not less than the specified determination time Td, the slowdown-determining portion 54 determines that the movement of the spool valve 45 has become slow. Also, when the detected value of a current detecting portion 51 does not descend after rising in a limit time TL which is longer than the determination time Td, the slowdown-determining portion 54 determines that the movement of the spool valve 45 has become slow.

Only when it is determined that the movement of the spool valve 45 has become slow, the PM-removing portion 55 performs a PM-removing operation for removing foreign matters between the valve body 44 and the spool valve 45. In the PM-removing operation, the solenoid 46 is repeatedly energized to move the spool valve 45 momentarily without varying the output oil pressure and engaging of the clutch 23.

The PM-removing portion 55 performs the a PM-removing operation repeatedly until the initial response time Ts becomes shorter than the determination time Td or the number of performing time reaches a specified number.

The adhere-determining portion 56 determines that the spool valve 45 is adhered to the valve body 44 when the initial response time Ts does not become shorter than the determination time Td even though the PM-removing operation is performed more than specified times.

### Operation of TCU 10

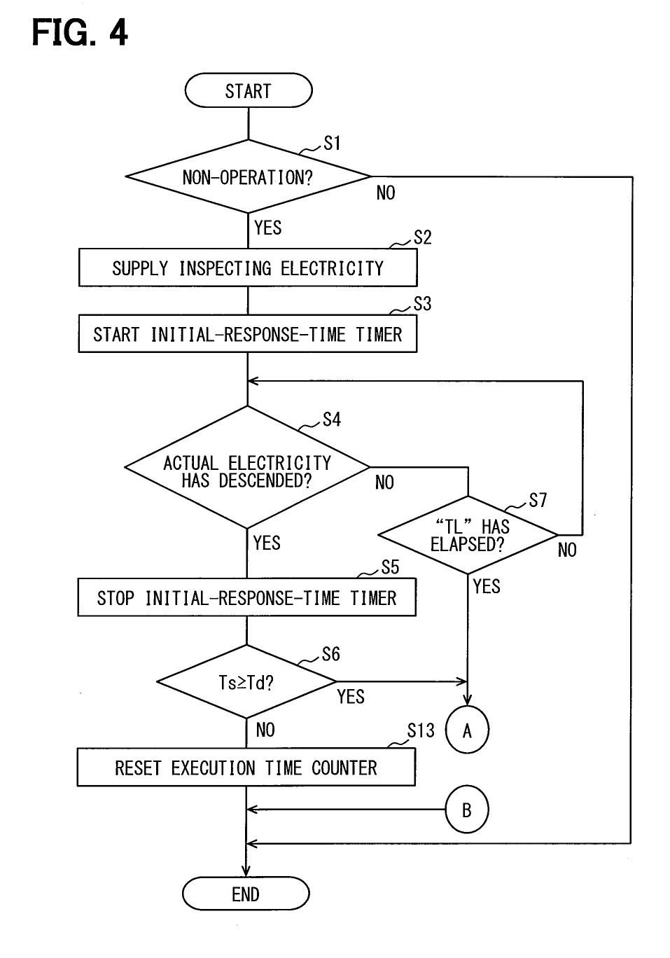

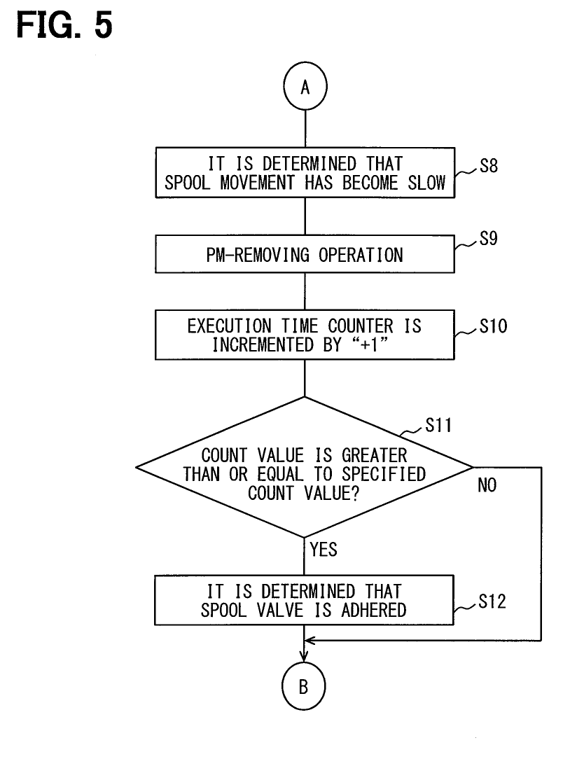

Referring to FIGS. 4 and 5, an operation of the TCU 10 will be explained. The following processing is repeatedly executed while the TCU 10 is ON.

In S1, it is determined whether the linear solenoid valve 31 is in non-operation condition based on the detected value of the current detecting portion 51. When the answer is Yes in S1, the procedure proceeds to S2. When the answer is No in S1, the procedure is terminated.

In S2, a command is outputted so that the inspecting electricity is supplied to the solenoid 46 for a predetermined period. Then, the procedure proceeds to S3.

In S3, an initial-response-time timer is started for clocking the initial response time Ts. Then, the procedure proceeds to S4.

In S4, it is determined whether the detected value of the current detecting portion 51 has descended after rising. When the answer is Yes in S4, the procedure proceeds to S5. When the answer is No in S4, the procedure proceeds to S7.

In S5, the initial-response-time timer is stopped and the current time of the timer is defined as the initial response time Ts. Then, the procedure proceeds to S6.

In S6, it is determined whether the initial response time Ts is greater than or equal to the determination time Td. When the answer is Yes in S1, the procedure proceeds to S2. When the answer is No in S11, the procedure proceeds to S13.

In S7, it is determined whether the limit time TL has elapsed from the command is generated in S2. When the answer is Yes in S7, the procedure proceeds to S8. When the answer is No in S7, the procedure goes back to S4.

In S8, it is determined that the movement of the spool valve 45 has become slow. Then, the procedure proceeds to S9.

In S9, the PM-removing portion 55 performs the PM-removing operation for removing foreign matters between the valve body 44 and the spool valve 45. Then, the procedure proceeds to S10.

In S10, an execution time counter is incremented by “+1”. The execution time counter counts a number of times of executing the PM-removing operation. Then, the procedure proceeds to S11.

In S11, it is determined whether the count value of the execution time counter is greater than or equal to a specified count value. When the answer is Yes in S11, the procedure proceeds to S12. When the answer is No in S11, the procedure is terminated.

In S12, it is determined that the spool valve 45 is adhered to the valve body 44. After S12, the procedure is terminated.

In S13, the execution time counter is reset to “0”. After S13, the procedure is terminated.

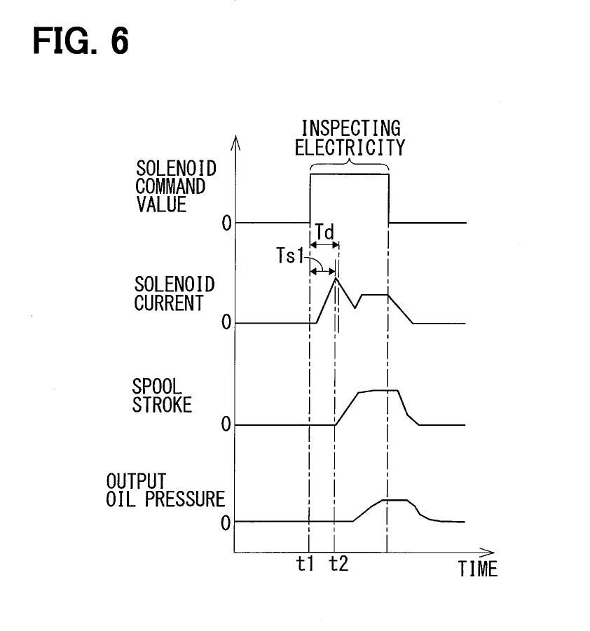

In a time chart shown in FIG. 6, the command of supplying the inspecting electricity is generated at a time t1, and the spool valve 45 starts moving at a time t2. The initial response time Ts1 from the time t1 to the time t2 is shorter than the determination time Td. Therefore, the TCU 10 determines that the movement of the spool valve 45 has not become slow, so that the PM-removing operation is not performed.

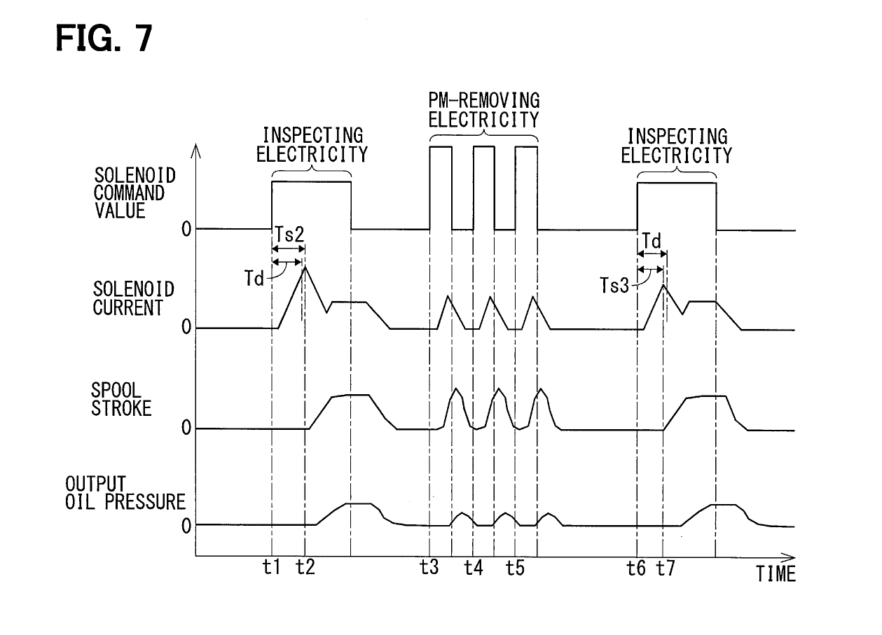

In a time chart shown in FIG. 7, the initial response time Ts2 from the time t1 to the time t2 is longer than the determination time Td. Therefore, the TCU 10 determines that the movement of the spool valve 45 has become slow, so that the PM-removing operation is performed during a period from the time t3 to the time t5. The command of supplying the inspecting electricity is generated at a time t6, and the spool valve 45 starts moving at a time t7. The initial response time Ts3 from the time t6 to the time t7 is shorter than the determination time Td Therefore, the TCU 10 determines that the movement of the spool valve 45 has not become slow, so that the PM-removing operation is not performed until a specified time period has elapsed.

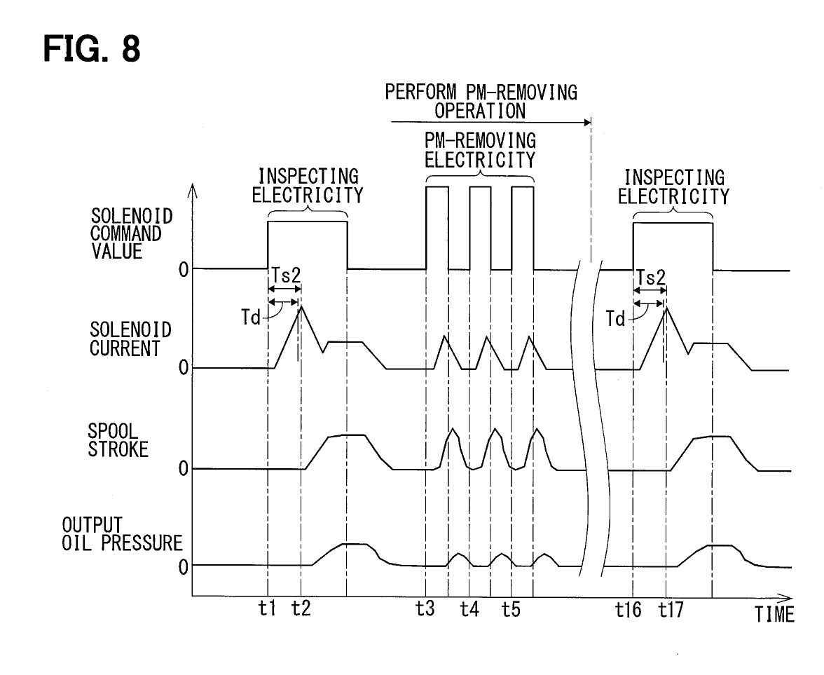

In a time chart shown in FIG. 8, the initial response time Ts2 that has elapsed from the time t1 to the time t2 is longer than the determination time Td. Therefore, the TCU 10 determines that the movement of the spool valve 45 has become slow, so that the PM-removing operation is performed during a period from the time t3 to the time t5. After the slowdown-determination and the PM-removing operation are performed at specified times, the initial response time Ts2 that has elapsed from the time t16 to the time t17 is still longer than the determination time Td. Therefore, the TCU 10 determines that the spool valve 45 is adhered to the valve body 44.

### Advantages

As explained above, in the present embodiment, the TCU 10 which controls the linear solenoid valve 31 is provided with the inspecting portion 52, the initial-response time computing portion 53, the slowdown-determining portion 54, and the PM-removing portion 55. The inspecting portion 52 supplies inspecting electricity toward the solenoid 46 for a predetermined period. The initial-response time computing portion 53 computes an initial response time Ts that has elapsed from the inspecting portion 52 commands to generate the inspecting electricity until the spool valve 45 starts moving. When the initial response time Ts is not less than the specified determination time Td, the slowdown-determining portion 54 determines that the movement of the spool valve 45 has become slow. Only when it is determined that the movement of the spool valve 45 has become slow, the PM-removing portion 55 performs a PM-removing operation for removing foreign matters between the valve body 44 and the spool valve 45.

By determining whether the movement of the spool valve 45 has become slow based on the initial response time Ts, it can be estimated whether foreign matters exist. When it is estimated that foreign matters exist, the PM-removing operation is performed. Therefore, when there is no foreign matter, it can avoid to perform the PM-removing operation and to consume useless electric power. Thus, according to the present embodiment, electric power consumption can be reduced.

Also, in the present embodiment, the inspecting portion 52 supplies the inspecting electricity when the linear solenoid valve 31 is not operated. Thus, the PM-removing operation can be performed without disturbing the transmission operation.

Moreover, in the present embodiment, the current detecting portion 51 detects actual electricity which flows into the solenoid 46. The initial response time Ts is defined as a time period that has elapsed from the inspecting portion 52 commands to generate the inspecting electricity until the detected value of the current detecting portion 51 starts descending after rising.

The initial response time Ts can be measured.

Also, when the detected value of a current detecting portion 51 does not descend after rising in the limit time TL which is longer than the determination time Td, the slowdown-determining portion 54 determines that the movement of the spool valve 45 has become slow.

According to the present embodiment, the PM-removing portion 55 performs the PM-removing operation repeatedly until the initial response time Ts becomes shorter than the determination time Td or the number of performing time reaches a specified number. Thereby, it is likely to avoid the slowdown of the spool movement.

According to the present embodiment, the adhere-determining portion 56 determines that the spool valve 45 is adhered to the valve body 44 when the initial response time Ts does not become shorter than the determination time Td even though the PM-removing operation is performed more than specified times. Thereby, it can be determined that the spool valve 45 is adhered to the valve body 44 and the spool valve 45 cannot move in its axial direction. Therefore, it can be identified whether the cause of malfunction of the clutch 23 is in the linear solenoid valve 31 or in other portions.

### Other Embodiment

According to the other embodiment, the initial-response time computing portion computes a peak value of the inspecting electricity. The time period from the command of the inspecting electricity to the peak value may be defined as the initial response time. The adhere-determining portion is not always necessary.

The linear solenoid valve may be applied to a non-stage transmission or a variable valve timing controller.

The present disclosure is not limited to the embodiment mentioned above, and can be applied to various embodiments.

What is claimed is:

1. A valve control apparatus controlling a linear solenoid valve which includes a valve body, a spool valve opening/closing a fluid passage defined in the valve body, and a solenoid driving the spool valve, the valve control apparatus comprising:
an inspecting portion which supplies an inspecting electricity to the solenoid;
an initial-response time computing portion which computes an initial response time that has elapsed from the inspecting portion commands to generate the inspecting electricity until the spool valve starts moving;
a slowdown-determining portion which determines that a motion of the spool valve has become slow when the initial response time is longer than or equal to a determination time; and
a PM-removing portion which performs a PM-removing operation in which the spool valve is axially moved so as to remove a foreign matter in the valve body.

2. The valve control apparatus according to claim 1, wherein the inspecting portion supplies the inspecting electricity to the solenoid when the linear solenoid valve is in a non-operation condition.

3. The valve control apparatus according to claim 1, further comprising:
a current detecting portion which detects an actual electricity flowing through the solenoid, wherein
the initial-response time computing portion defines the initial response time that has elapsed from the inspecting portion commands to generate the inspecting electricity until the detected value of the current detecting portion starts descending after rising.

4. The valve control apparatus according to claim 3, wherein
the slowdown-determining portion determines that the motion of the spool valve has become slow when the detected value of the current detecting portion does not descend in a period from the inspecting portion is commanded to supply the inspecting electricity until a limit time is elapsed.

5. The valve control apparatus according to claim 1, wherein
the PM-removing portion repeatedly performs the PM-removing operation until the initial response time becomes shorter than the determination time or a number of times of executing the PM-removing operation reaches a specified number of times.

6. The valve control apparatus according to claim 5, further comprising:
an adhere-determining portion which determines that the spool valve is adhered to the valve body when the initial response time does not become shorter than the determination time even though the PM-removing operation has been performed more than the specified number of times.
